(19) United States
(12) Patent Application Publication
(10) Pub. No.: US 2013/0060659 A1
(43) Pub. Date: Mar. 7, 2013

(54) SYSTEM AND METHOD FOR SPLITTING COLLABORATION ON EVENT METRICS FOR A SUPPLIER TO RESPOND TO BASED ON FUNCTIONAL ROLE

(71) Applicants: Daniel Velasquez, Eden, UT (US); Joanna Dakes, Tucson, AZ (US)

(72) Inventors: Daniel Velasquez, Eden, UT (US); Joanna Dakes, Tucson, AZ (US)

(73) Assignee: Oracle International Corporation, Redwood Shores, CA (US)

(21) Appl. No.: 13/225,187

(22) Filed: Sep. 2, 2011

(51) Int. Cl. G06Q 30/00

(52) U.S. Cl. 705/26.35

(57) ABSTRACT

Embodiments of the invention relate to methods and systems of splitting collaboration on event metrics for a supplier to respond to based on functional role. The method includes establishing review groups. Each of the review groups includes at least one user. The method further includes associating bid factors to one or more of the review groups, displaying each of the bid factors in accordance with the association of the bid factors with each of the review groups, receiving rankings for each of the bid factors from each of the review groups associated with the bid factors, receiving answers to each of the bid factors from at least one supplier, ranking each of the answers to the bid factors. and correlating the rankings for each of the rankings of the bid factors and the rankings of the answers to generate a score for the at least one supplier.

### BACKGROUND

Currently, a consumer may solicit bids from a supplier which desires to provide goods, services, etc. This may be done by creating an event that poses questions to the supplier. The consumer can then measure the suppliers' responses to the questions and rate the supplier based on such responses. The consumer may have many groups that rate the suppliers' responses including, for example, a legal department, an IT department, functional users, etc. However, these questions would not be collaborated on by such groups. Hence, for these and other reasons, improvements are needed in the art.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIGS. 1A and 1B illustrate methods of splitting collaboration on event metrics for a supplier to respond to based on functional role, according to embodiments of the present invention.

FIG. 2 illustrates a method of splitting collaboration on event metrics for a supplier to respond to based on functional role, according to a further embodiment of the present invention.

FIG. 3 illustrates a system for splitting collaboration on event metrics for a supplier to respond to based on functional role, according to an embodiment of the present invention.

FIGS. 4A-4K illustrate user interfaces for splitting collaboration on event metrics for a supplier to respond to based on functional role, according to an embodiment of the present invention.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

### SUMMARY OF THE INVENTION

One embodiment of the invention relates to a method of splitting collaboration on event metrics for a supplier to respond to based on functional role. The method includes establishing a plurality of review groups. Each of the plurality of review groups includes at least one user. The method further includes associating bid factors to one or more of the plurality of review groups, displaying each of the bid factors in accordance with the association of the bid factors with each of the plurality of review groups, receiving rankings for each of the bid factors from each of the plurality of review groups associated with the bid factors, receiving answers to each of the bid factors from at least one supplier, ranking each of the answers to the bid factors. and correlating the rankings for each of the rankings of the bid factors and the rankings of the answers to generate a score for the at least one supplier.

The method further includes assigning the bid factors to an event header and line items, setting up notification settings for each of the plurality of review groups, and based on the notification settings, notifying each of the users in each of the plurality of review groups about the status of the collaboration. Further, the method includes generating worklist items for each of the users, restricting view of bid factors based on the review group of the user, restricting view of answers based on the review group of the user, and providing each user with the ability to accept or reject rankings of the bid factors and answers.

Another embodiment of the invention describes a system for splitting collaboration on event metrics for a supplier to respond to based on functional role. The system includes a storage device having sets of instructions stored thereon, and a processor coupled with the storage device. The sets of instructions when executed by the processor, cause the processor to: establish a plurality of review groups, wherein each of the plurality of review groups includes at least one user, associate bid factors to one or more of the plurality of review groups, display each of the bid factors in accordance with the association of the bid factors with each of the plurality of review groups, receive rankings for each of the bid factors from each of the plurality of review groups associated with the bid factors, receive answers to each of the bid factors from at least one supplier, rank each of the answers to the bid factors, and correlate the rankings for each of the rankings of the bid factors and the rankings of the answers to generate a score for the at least one supplier.

Furthermore, the system includes a consumer computing device, wherein the consumer computing device includes a metric identification engine and a metric evaluation engine and a supplier computing device in communication with the consumer computing device. Further, the system includes the bid factors are presented to the suppliers as a RFx or a RFI. Further, the sets of instructions when executed by the processor, further cause the processor to during analysis set up collaboration parameters within each of the plurality of review groups, and dates and times to have review complete for each user. Furthermore, each user is a collaborator and wherein each of the bid factors is restricted to collaborators not associated with the bid factor, and the bid factors are questions presented to the suppliers.

In yet another embodiment, a computer-readable medium is described. The sets of instructions when executed by the processor, further cause the processor to restrict view of bid factors based on the review group of the user, and establish a plurality of review groups. Each of the plurality of review groups includes at least one user. Further, the sets of instructions when executed by the processor, further cause the processor to associate bid factors to one or more of the plurality of review groups, display each of the bid factors in accordance with the association of the bid factors with each of the plurality of review groups, receive rankings for each of the bid factors from each of the plurality of review groups associated with the bid factors, receive answers to each of the bid factors from at least one supplier, rank each of the answers to the bid factors, and correlate the rankings for each of the rankings of the bid factors and the rankings of the answers to generate a score for the at least one supplier.

The sets of instructions when further executed by the computer, cause the computer to receive additional bid factors, receive rankings for the additional bid factors, rank each of the plurality of review groups, wherein the ranking of the review groups is factored in the generation of the score for the at least one supplier, and restrict view of bid factors based on the review group of the user. Furthermore, more than one of the plurality of review groups are associated with at least one of the bid factors, and the plurality of review groups includes one or more of: a legal group, an IT group, or a functional group.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

Aspects of the present invention relate to restricting access to questions to certain groups of individuals during collaboration before an event occurs and also to segregating duties to certain groups of individuals during collaboration before an event occurs. During collaboration, each review group can collaborate on and review questions that apply to their functional area of expertise, and not see the questions that do not apply. Some of these questions would be considered restricted to specific groups of people, and this feature enables the questions to not be shared amongst all the collaborators.

Accordingly, the consumer can create review groups, or the like, in which collaborators can be added. Once the groups of users are created, they can be assigned to specific questions for collaborating, and can also contribute to the different parameters for the questions. The collaborators' choices may be consolidated into one page for the buyer to review and make a choice based on the reviews. Since the questions are only sent to the experts in each area that the questions pertain, the responses have more validity and credibility. Furthermore, the consumer can also assign a weight to each review group to give them more or less weight in the final choices. They can also default to a specific question for a review group.

One advantage of the present invention may be that the event questions during collaboration are sent only to the functional people that have expertise relevant to each question, and specific questions are not sent to people within an organization that should not know about the types of questions and what is being asked. Also, review groups that have more expertise in the area which the question addresses can be given more weight to have the system automatically take the higher importance into account during final question parameter selection.

Furthermore, review groups during pre-event collaboration only see the questions that pertain to their functional role in rating the supplier, thus saving time and simplifying the process for users. This will make products more usable for collaborating on the questions sent to sourcing suppliers, make the process more streamlined, and ensure that security of information is maintained.

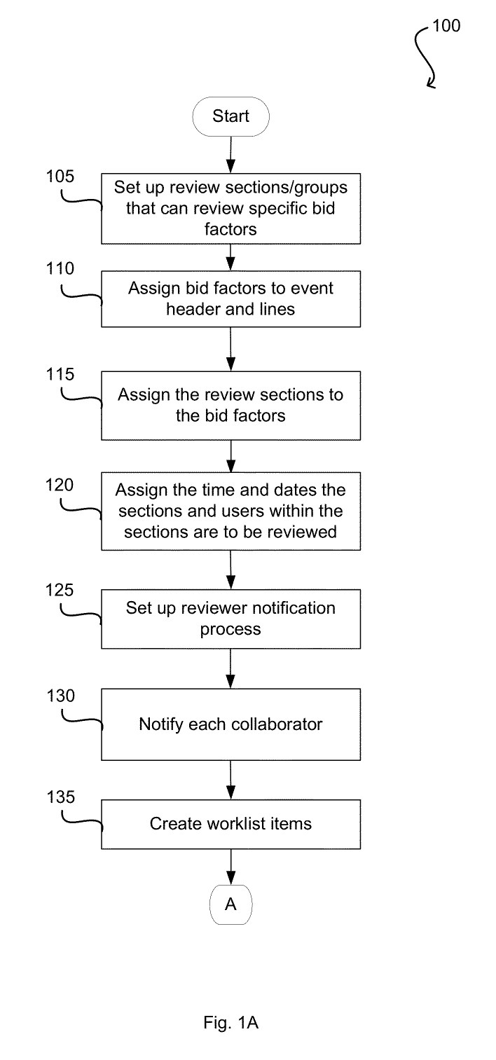

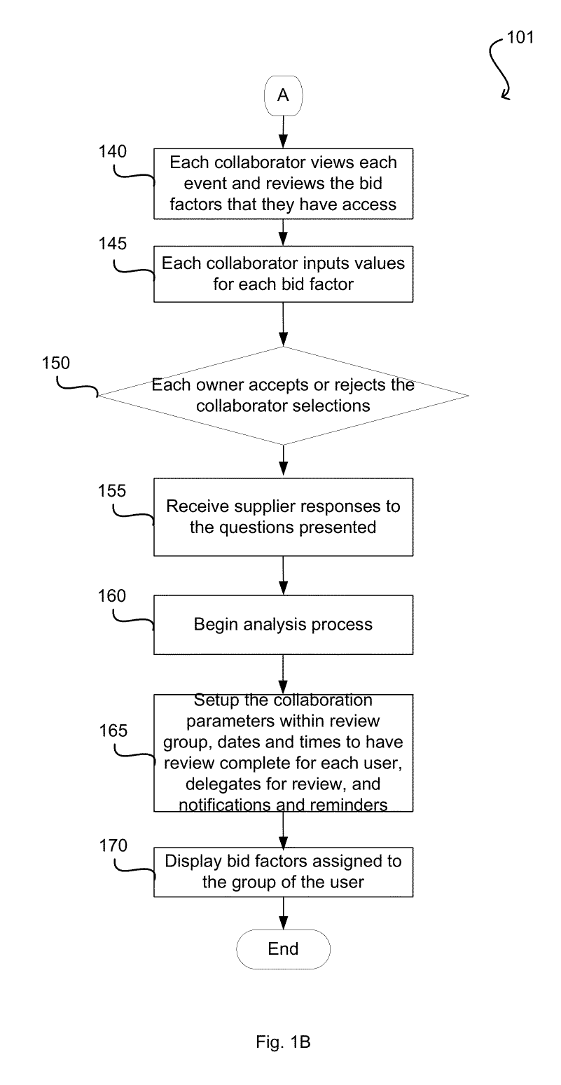

Turning now to FIG. 1A, a method 100 of splitting collaboration on event metrics for a supplier to respond to based on functional role is illustrated. At process block 105, review groups or review sections may be established. In one embodiment, the review groups may be configured to review specific bid factors (or vendor questions). The review groups may be established for specific working groups or divisions within a company or organization. For example, the review groups may include legal, technology, customer service, sales, human resources, etc. Each group may be granted certain rights to review bid factors and/or present new bid factors. Furthermore, default settings may be provided for bid factors when no specific review group is specified.

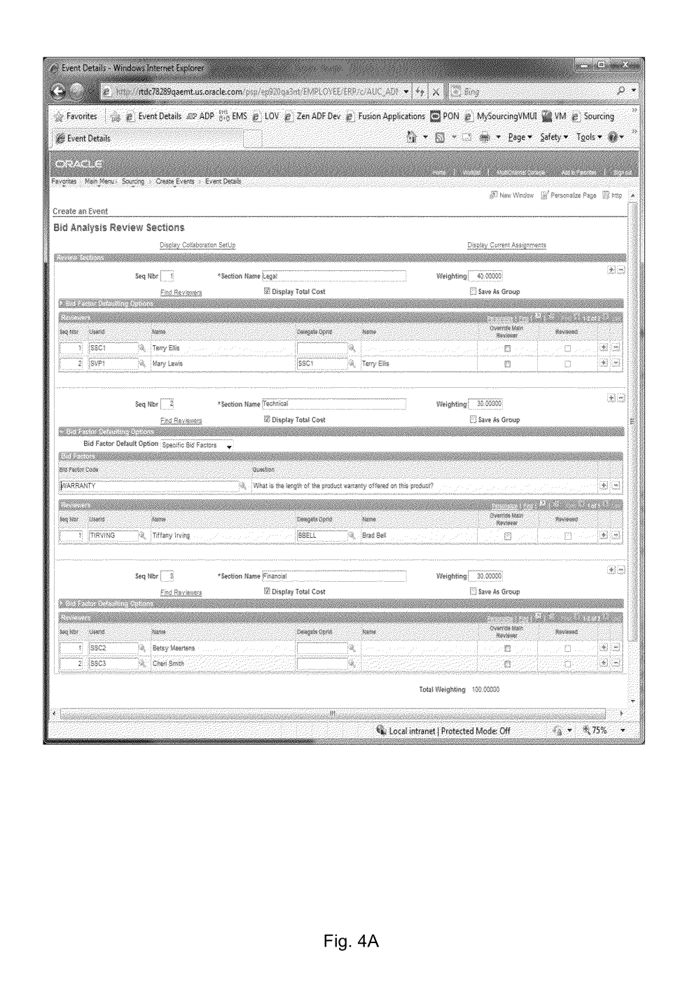

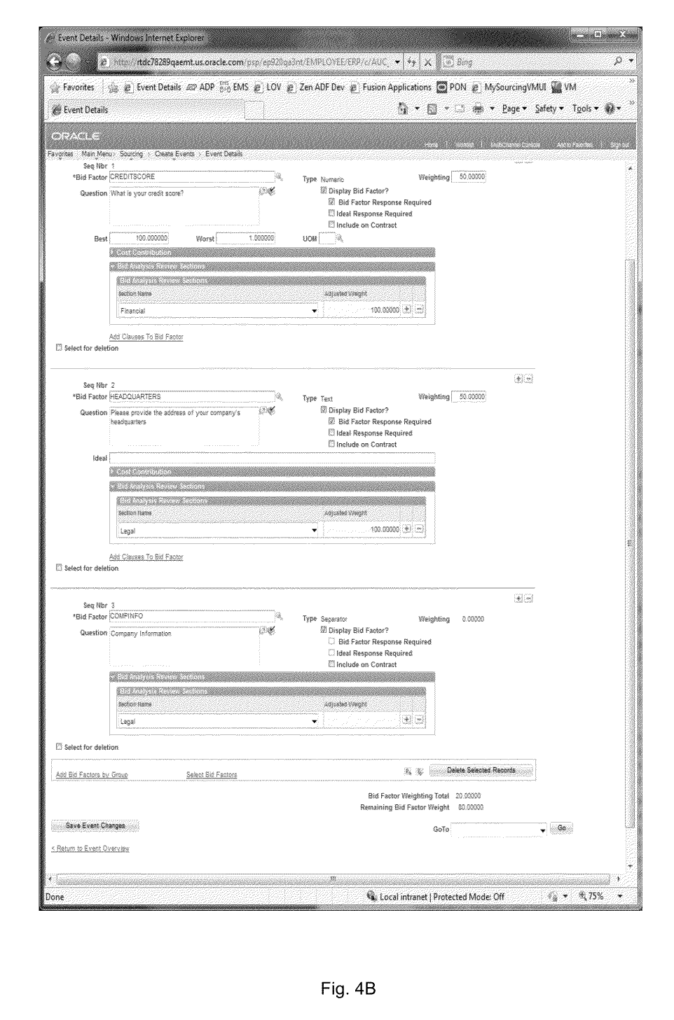

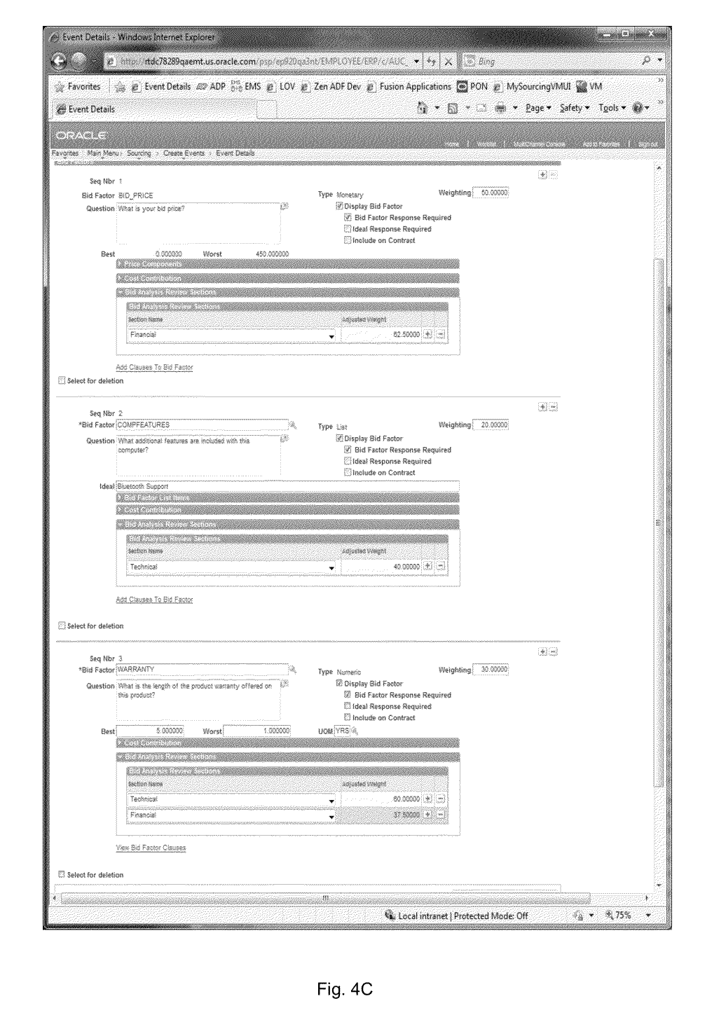

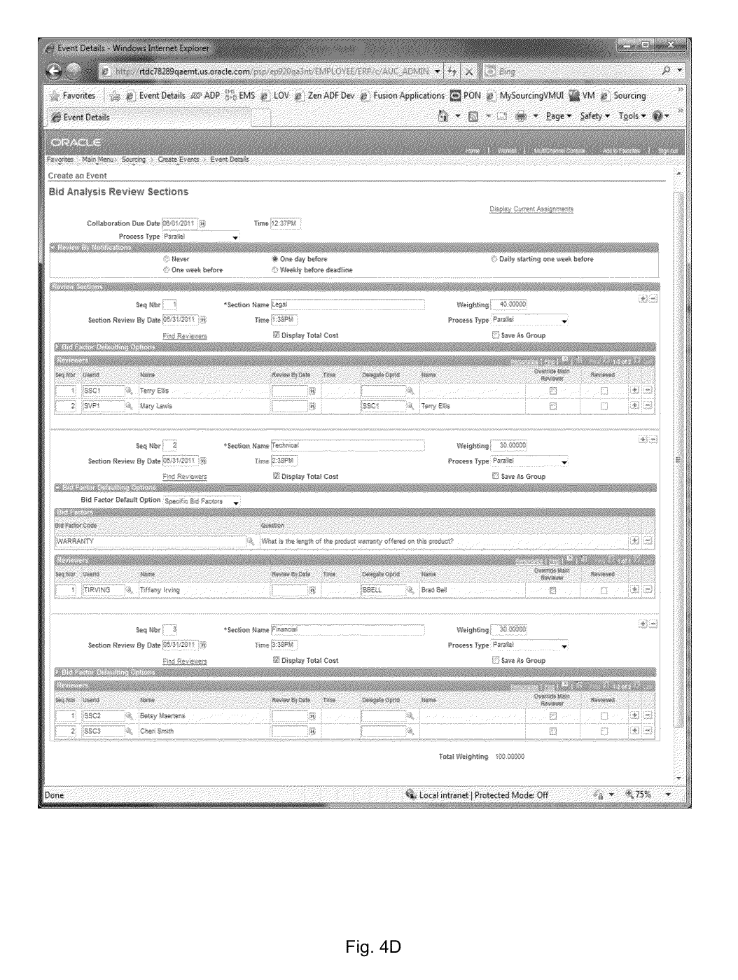

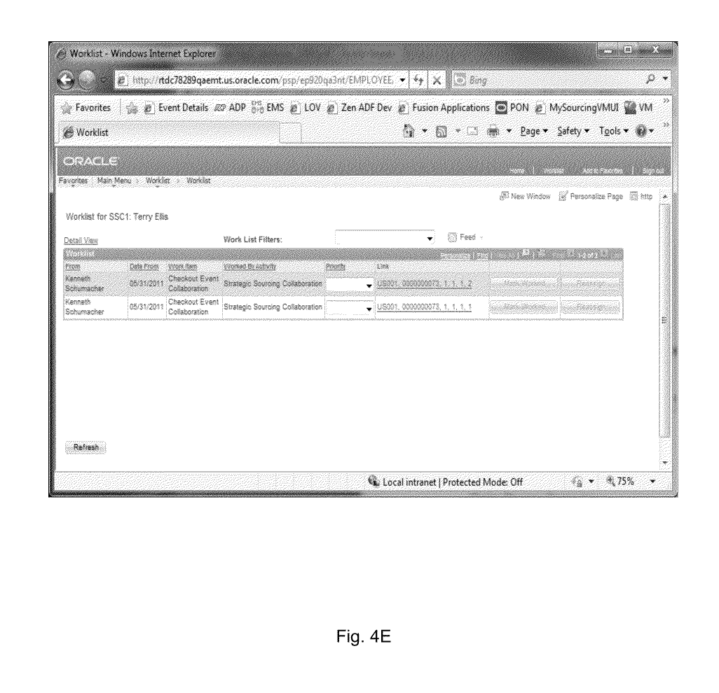

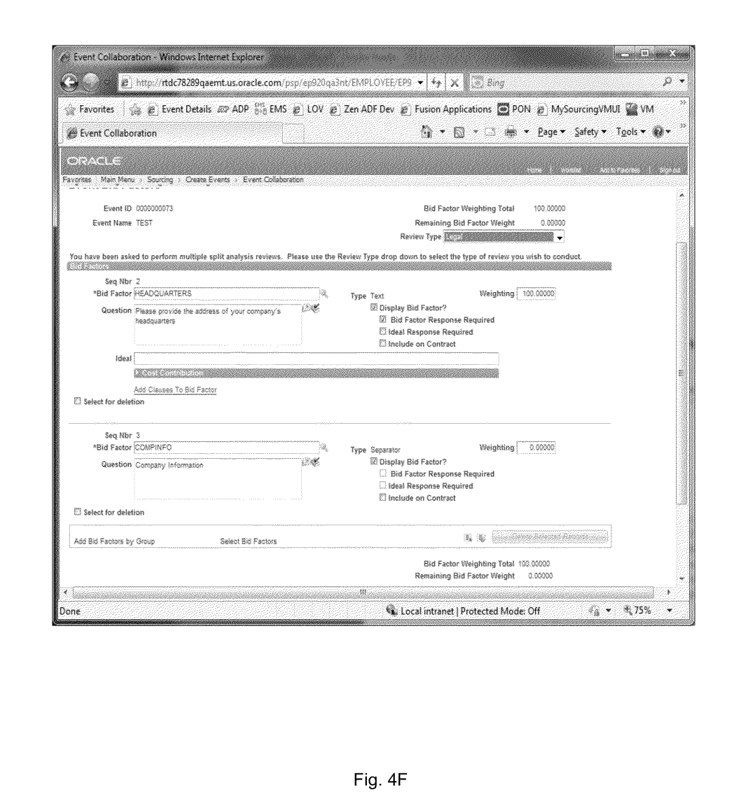

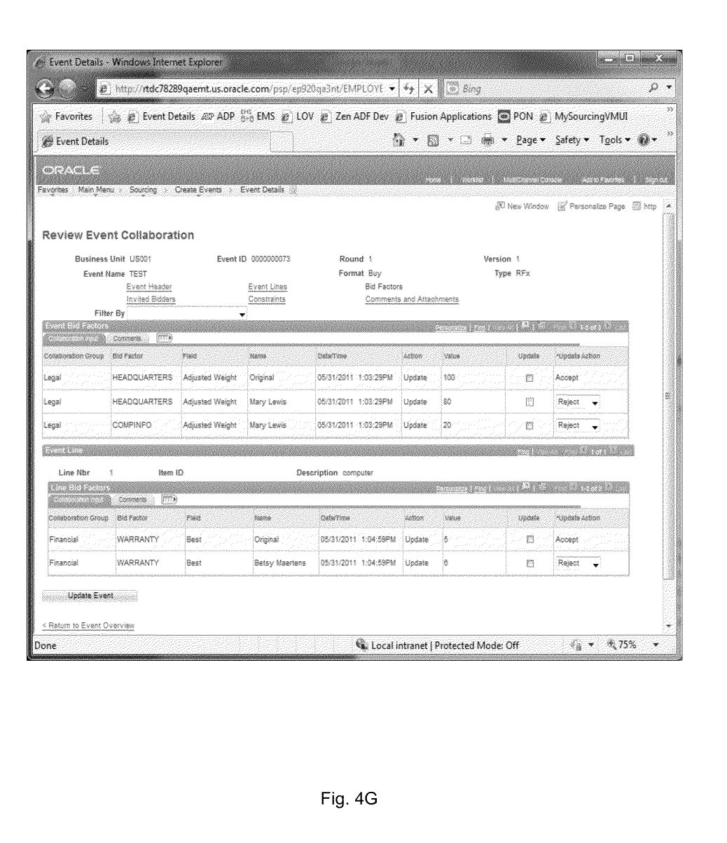

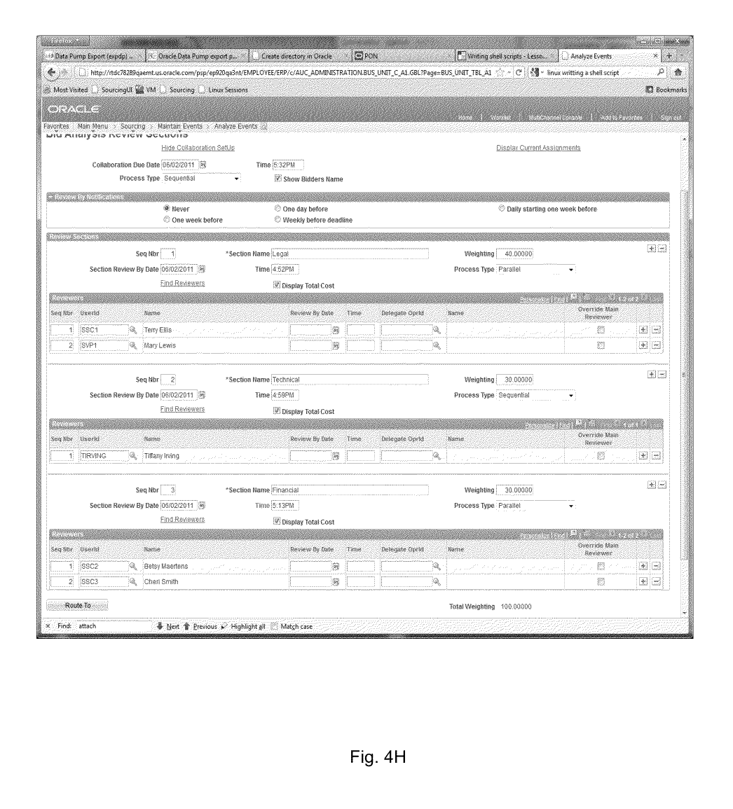

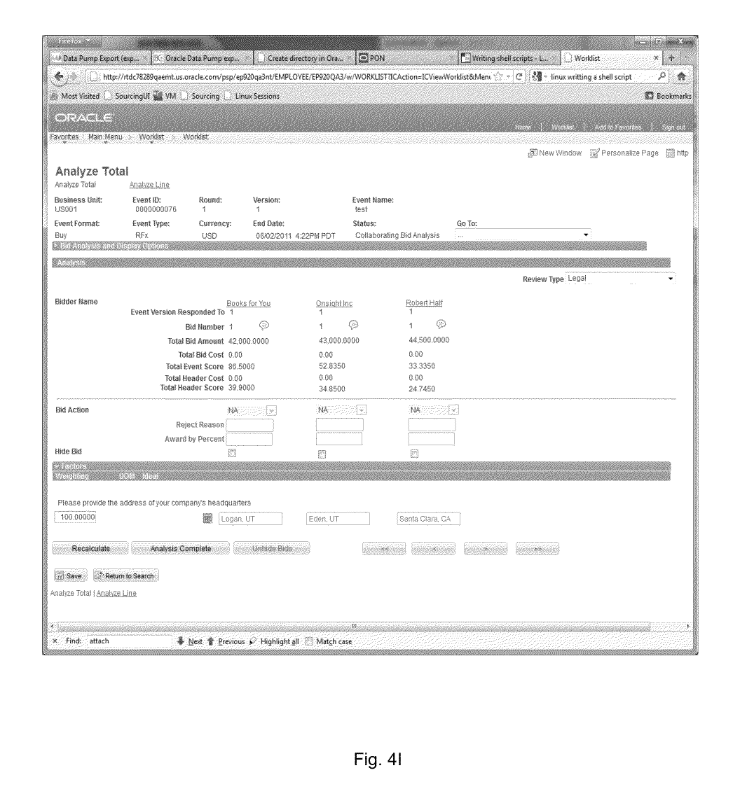

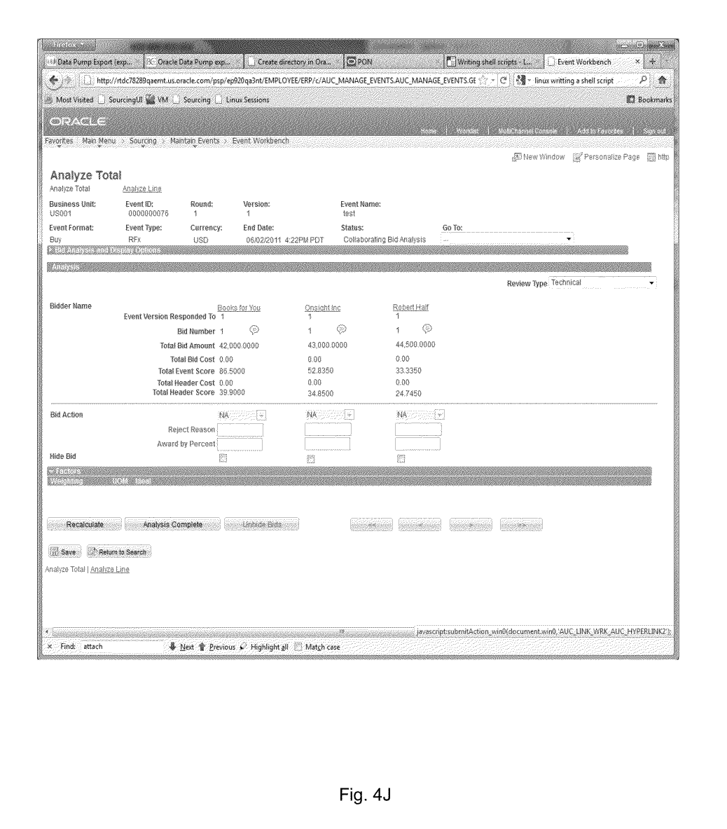

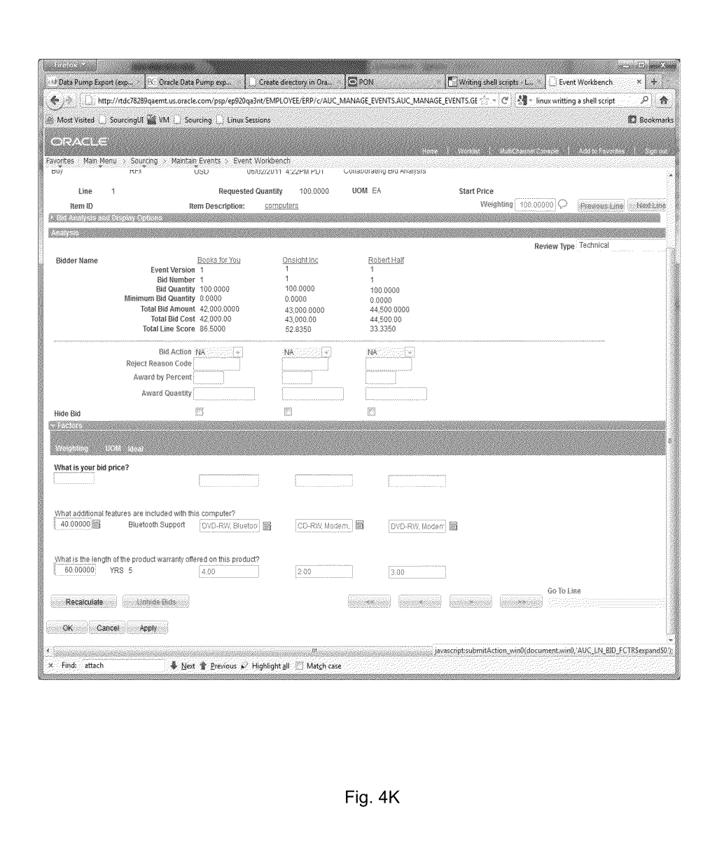

One embodiment of review groups being established is shown in FIG. 4A. For example, there are three review groups shown: legal, technical, and financial, and each of the groups includes specific members. In this UI, members can be added or removed and, in addition, bid factors can also be added and removed.

At process block 110, bid factors are assigned to event headers and lines. As can be seen in FIG. 4B, each bid factor may be generated, and a weighted value may be assigned. Furthermore, each bid factor can be assigned one or more review groups. For example, in FIG. 4B the ‘CREDITSCORE’ bid factor is assigned to the Financial review group and has a weight of 50, the ‘HEADQUARTERS’ bid factor is assigned to the Legal review group and has a weight of 50, and the ‘COMPINFO’ bid factor is assigned to the Legal review group and has a weight of 0. Furthermore, as can be seen, each bid factor includes associated vendor questions, for example, the ‘CREDITSCORE’ bid factor includes ‘What is your credit score?’ and so forth.

Further, at process block 115, the review groups are assigned to the bid factors, also as shown in FIG. 4B. More than one review group can be assigned to a bid factor as shown with line one warranty bid factor (see FIG. 4C).

At process block 120, times and dates for which the review groups and the users within the review groups must review the bid factors are assigned. These can be set up in parallel or sequentially for review between the authorized review groups as well as in parallel or sequentially for reviewing within the review groups themselves. As can be seen in FIG. 4D, date and time information may be entered for each review group. For example, the Legal review group is to review all of the bid factors, in parallel, by Jun. 1, 2011 at 1:30 pm.

Furthermore, at process block 125, notification for the reviewers may be set up. As such, each collaborator is notified (process block 130), and a worklist item is then created (process block 135). In FIG. 4E, a worklist for SSC1: Terry Ellis is created, and notifications for Kenneth Schumacher are generated.

Turning now to FIG. 1B which continues the illustration of method 100. Continuing from point ‘A’ to process block 140, each collaborator checks out the event and reviews the bid factors they are allowed to see (i.e., the bid factors for which their assigned review group is associated with) in the event and inserts values the reviewer believes are appropriate for the specific bid factors (process block 145). It should be noted that only the bid factors which are associated with the reviewer's group are made available to the reviewer. FIG. 4F shows one embodiment of a user interface which provides reviewers with an interface to view assigned questions and enter review information for each of the answered questions.

At decision block 150, the event owner(s) can accept or reject the collaborators' choices. In one embodiment, drop-down boxes associated with each of the bid factors can be presented which can be selected to “accepted” or “rejected” (see FIG. 4G). Then, at process block 155, the suppliers respond to the request for x (RFx) or request for information (RFI). After all of the questions are answered and time has expired, the analysis begins (process block 160).

At process block 165, during analysis, the same collaboration parameters, overall parallel/sequential, within review group parallel/sequential, dates and times to have review complete for each user, delegates for review, and notifications and reminders may be used; however, these parameters may also be modified. The analysis process may be performed using the UI presented in FIG. 4H. At process block 170, the bid factors and associated answers are then displayed to each user within a review group based on the group. As such, only the bid factors associated with the group are displayed to members of that group and all other bid factors are filtered out.

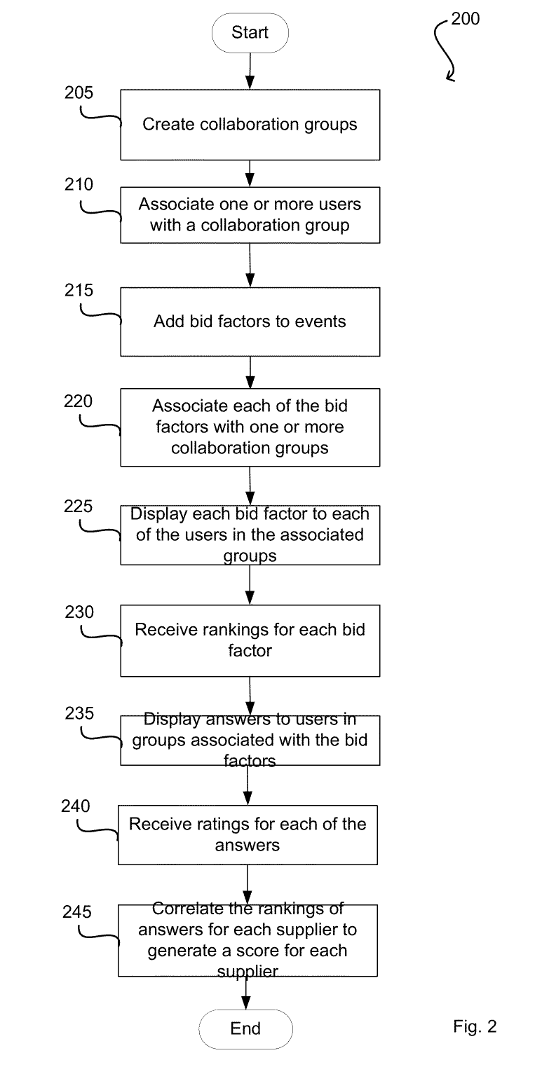

Referring next to FIG. 2, a method 200 of splitting collaboration on event metrics for a supplier to respond to based on functional role is illustrated. At process block 205, collaboration groups are created. In one embodiment, these groups may include any subset of users which may be involved in a vendor/supplier review process. As such, one or more users may be associated with each collaboration group (process block 210).

At process block 215, bid factors may be added to events, and each of the bid factors is associated with one or more collaboration groups (process block 220). As such, each of the bid factors which are associated with each of the collaboration groups is displayed to the members of the specific group (process block 225). Therefore, only the bid factors for which a user within a collaboration group is authorized to see are displayed for the user. Accordingly, the displayed bid factors will change for each user and each collaboration group.

At process block 230, rankings for each bid factor are received. These rankings may be received by each user or may be collectively received for each group. For example, each member in the legal group may rank the bid factors, and then an average of all the legal user rankings may be presented as the legal group's ranking. Alternatively, each individual legal group user ranking may be used separately. Furthermore, each group may have a ranking. For example, the legal group may be ranked higher than the technical group, which means that the ranking from the legal group will be weighted higher than the rankings from the technical group, and so forth.

Then, as answers to the bid factors are received, the answers that are associated with a user's group are displayed to the users (process block 235). Accordingly, the answers are also rated by the users of each of the authorized groups (process block 240). Then, the rankings of the answers from each of the suppliers are correlated to generate a score for each supplier (process block 245). The suppliers are then ranked based on scores assigned to each supplier.

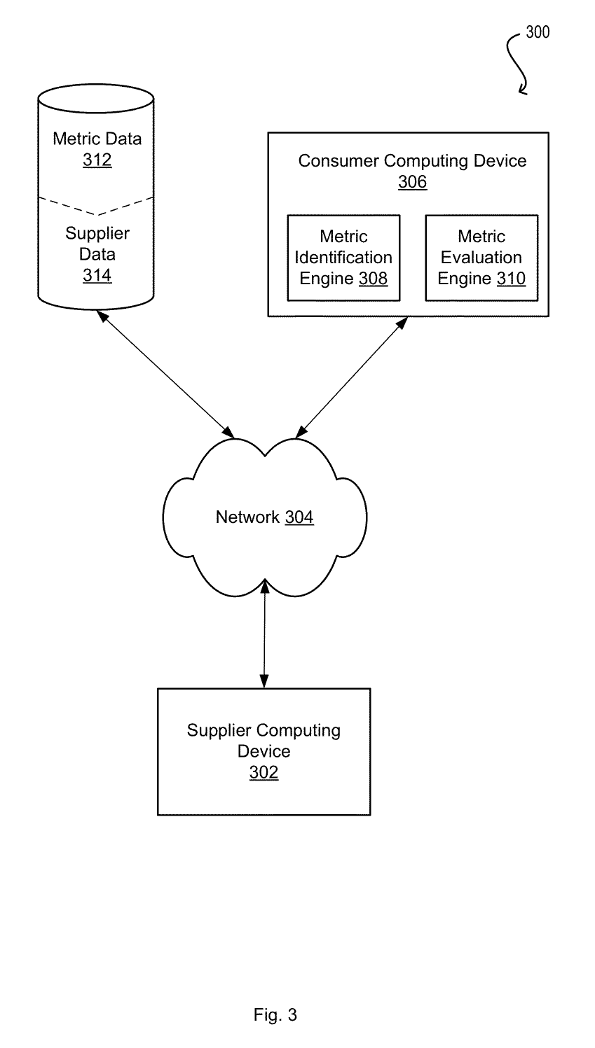

Referring now to FIG. 3, a schematic diagram of an exemplary architecture for identifying sourcing event metrics for analyzing a supplier is shown. Supplier computing device 302 is coupled to consumer computing device 306 via network 304. Supplier computing device 302 may be any type of computing device suitable for use with the present invention, such as a computer, a personal digital assistant (PDA), a wireless device, and so on. Further, network 304 may include any type of network suitable for use with the present invention, such as a wide area network (WAN), like the Internet, a local area network (LAN), a wireless network, etc.

Consumer computing device 306 includes metric identification engine 308 and metric evaluation engine 310 in one embodiment of the invention. Consumer computing device 306 may be any type of computing device suitable for use with the present invention, such as a computer, a PDA, a wireless device, etc.

Metric identification engine 308 identifies metrics for evaluating a supplier. For instance, a user may create original, or otherwise new, metrics utilizing metric identification engine 308, locate previously created metrics utilizing metric identification engine 308, etc. Metric evaluation engine 310 evaluates the supplier utilizing the metrics identified via metric identification engine 308. For example, metric evaluation engine 310 may include instructions for rating a supplier according to metrics identified by the consumer, or a user generally. Exemplary processes performed by metric identification engine 308 and metric evaluation engine 310 are further discussed herein.

Metric data 312 and supplier data 314 represent data storage. As shown in FIG. 3, metric data 312 and supplier data 314 are accessible by consumer computing device 306 via network 304. However, metric data 312 and supplier data 314 may be directly coupled to consumer computing device 306 in one embodiment. Metric data 312 and supplier data 314 may be stored in a single database or separate databases. Any type of data storage suitable for use with the present invention may be employed for storing metric data 312 and supplier data 314.

As discussed herein, the consumer represents a user soliciting bids associated with a product, service, etc. The supplier represents a user submitting information related to the bid associated with the particular product, service, etc. Generally, the supplier submits bid-related data to the consumer in the context of a sourcing event. A sourcing event includes any event that represents the product, service, etc. that the consumer desires to evaluate. The sourcing event is created in order to represent the metrics the consumer may utilize to “measure” the supplier. These “measurements” may be utilized to help the consumer reach a decision as to which supplier(s) the consumer will choose to provide the particular products, service, etc.

A supplier may be invited by the consumer to “bid” on one or more sourcing events. For instance, the supplier may be invited to bid on an office furniture sourcing event and a computer hardware sourcing event. The “bid” provided by the supplier can represent a wide range of data input by the supplier, the data analyzed utilizing the metrics discussed herein. For example, the supplier's bid may include data related to price, warranty, service contract terms, etc.

Turning now to FIG. 4I, a user interface which shows a user SSC1 logging in to the system is illustrated, and only the bid factors marked for legal are displayed since user SSC1 is part of the legal review group. Furthermore, all of the weightings are prorated for the user so that the ratings all add up to 100 no matter how many of the bid factors the user is authorized to view. At FIG. 4J, the technical review group is displayed but none of the bid factors at the header level are displayed since the technical review group was not assigned bid factors. Furthermore, as can be seen in FIG. 4K, the technical review group can see all of the line level items because the group was assigned to all of the line level items.

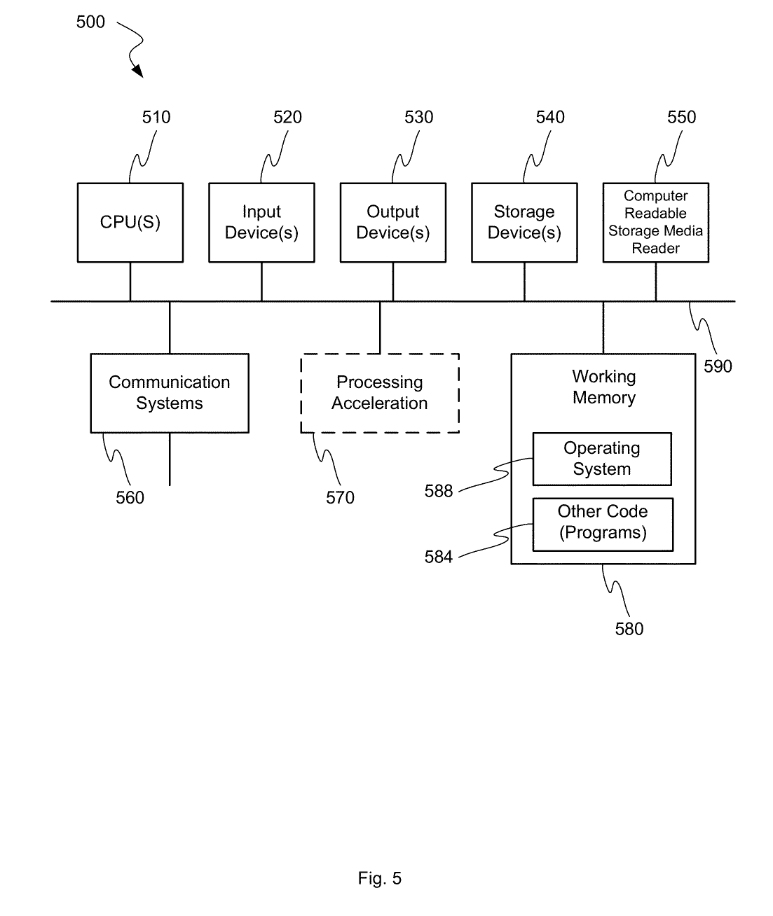

FIG. 5 is a block diagram illustrating an exemplary computer system 500 in which embodiments of the present invention may be implemented. The computer system 500 is shown comprising hardware elements that may be electrically coupled via a bus 590. The hardware elements may include one or more central processing units 510, one or more input device(s) 520 (e.g., a mouse, a keyboard, etc.), and one or more output device(s) 530 (e.g., a display device, a printer, etc.). The computer system 500 may also include one or more storage device(s) 540. By way of example, storage device(s) 540 may be disk drives, optical storage devices, a solid-state storage device such as a random access memory (“RAM”) and/or a read-only memory (“ROM”), which can be programmable, flash-updateable and/or the like.

The computer system 500 may additionally include a computer-readable storage media reader 550, a communication system 560 (e.g., a modem, a network card (wireless or wired), an infra-red communication device, Bluetooth™ device, cellular communication device, etc.), and working memory 580, which may include RAM and ROM devices as described above. In some embodiments, the computer system 500 may also include a processing acceleration unit 570, which can include a digital signal processor, a special-purpose processor, and/or the like.

The computer-readable storage media reader 550 can further be connected to a computer-readable storage medium, together (and, optionally, in combination with storage device(s) 540) comprehensively representing remote, local, fixed, and/or removable storage devices plus storage media for temporarily and/or more permanently containing computer-readable information. The communication system 560 may permit data to be exchanged with a network, system, computer, and/or other components described above.

The computer system 500 may also comprise software elements, shown as being currently located within a working memory 580, including an operating system 588 and/or other code 584. It should be appreciated that alternate embodiments of a computer system 500 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 500 may include code 584 for implementing any or all of the functions of the various elements of the architecture as described herein. For example, software, stored on and/or executed by a computer system such as system 500, can provide the functionality and/or other components of the invention such as those discussed above. Methods implementable by software on some of these components have been discussed above in more detail.

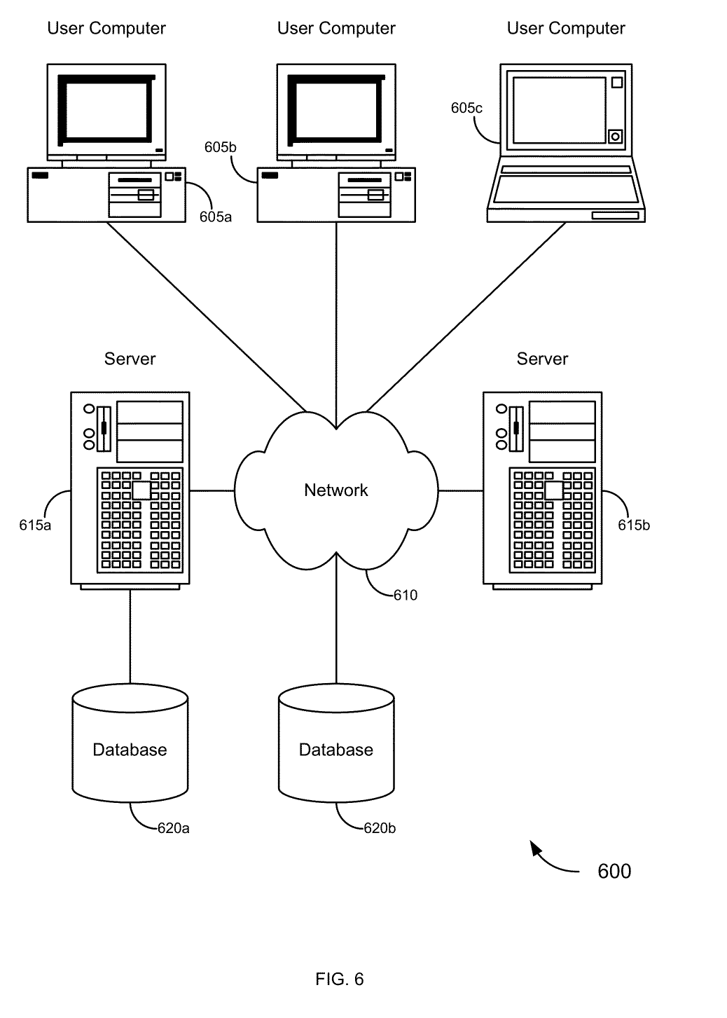

Merely by way of example, FIG. 6 illustrates a schematic diagram of a system 600 that can be used in accordance with one set of embodiments. The system 600 can include one or more user computers 605. The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially available protocols, including without limitation TCP/IP, SNA, IPX, AppleTalk, and the like. Merely by way of example, the network 610 can be a local area network (“LAN”), including without limitation an Ethernet network, a Token-Ring network, and/or the like; a wide-area network (WAN); a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more user computers 605 and/or other server computers 615.

Merely by way of example, one of the server computers 615 may be a web server, which can be used, merely by way of example, to process requests for web pages or other electronic documents from user computers 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications accessible by a client running on one or more of the user computers 605 and/or other server computers 615. Merely by way of example, the server computers 615 can be one or more general purpose computers capable of executing programs or scripts in response to the user computers 605 and/or other server computers 615, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 605 and/or another server computer 615. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more server computers 615 can function as a file server and/or can include one or more of the files (e.g., application code, data files, etc.) necessary to implement methods of the invention incorporated by an application running on a user computer 605 and/or another server computer 615. Alternatively, as those skilled in the art will appreciate, a file server can include all necessary files, allowing such an application to be invoked remotely by a user computer 605 and/or server computer 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more database(s) 620. The location of the database(s) 620 is discretionary. Merely by way of example, a database 620a might reside on a storage medium local to (and/or resident in) a server computer 615a (and/or a user computer 605). Alternatively, a database 620b can be remote from any or all of the computers 605, 615, so long as the database can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle™ database, that is adapted to store, update, and retrieve data in response to SQL-formatted commands. The database might be controlled and/or maintained by a database server, as described above, for example.

The invention has now been described in detail for the purposes of clarity and understanding. However, it will be appreciated that certain changes and modifications may be practiced within the scope of the appended claims.

What is claimed:

1. A method of splitting collaboration on event metrics for a supplier to respond to based on functional role, the method comprising:
establishing a plurality of review groups, wherein each of the plurality of review groups includes at least one user;
associating bid factors to one or more of the plurality of review groups;
displaying each of the bid factors in accordance with the association of the bid factors with each of the plurality of review groups;
receiving rankings for each of the bid factors from each of the plurality of review groups associated with the bid factors;
receiving answers to each of the bid factors from at least one supplier;
ranking each of the answers to the bid factors; and
correlating the rankings for each of the rankings of the bid factors and the rankings of the answers to generate a score for the at least one supplier.

2. The method of splitting collaboration on event metrics for the supplier to respond to based on functional role as in claim 1, further comprising assigning the bid factors to an event header and line items.

3. The method of splitting collaboration on event metrics for the supplier to respond to based on functional role as in claim 1, further comprising:
setting up notification settings for each of the plurality of review groups; and
based on the notification settings, notifying each of the users in each of the plurality of review groups about the status of the collaboration.

4. The method of splitting collaboration on event metrics for the supplier to respond to based on functional role as in claim 1, further comprising based on the bid factors, generating worklist items for each of the users.

5. The method of splitting collaboration on event metrics for the supplier to respond to based on functional role as in claim 1, further comprising restricting view of bid factors based on the review group of the user.

6. The method of splitting collaboration on event metrics for the supplier to respond to based on functional role as in claim 5, further comprising restricting view of answers based on the review group of the user.

7. The method of splitting collaboration on event metrics for the supplier to respond to based on functional role as in claim 6, further comprising providing each user with the ability to accept or reject rankings of the bid factors and answers.

8. A system for splitting collaboration on event metrics for a supplier to respond to based on functional role, the system comprising:
a storage device having sets of instructions stored thereon; and
a processor coupled with the storage device, wherein the sets of instructions when executed by the processor, cause the processor to:
establish a plurality of review groups, wherein each of the plurality of review groups includes at least one user;
associate bid factors to one or more of the plurality of review groups;
display each of the bid factors in accordance with the association of the bid factors with each of the plurality of review groups;
receive rankings for each of the bid factors from each of the plurality of review groups associated with the bid factors;
receive answers to each of the bid factors from at least one supplier;
rank each of the answers to the bid factors; and
correlate the rankings for each of the rankings of the bid factors and the rankings of the answers to generate a score for the at least one supplier.

9. The system of splitting collaboration on event metrics for the supplier to respond to based on functional role as in claim 8, further comprising:
a consumer computing device, wherein the consumer computing device includes a metric identification engine and a metric evaluation engine; and
a supplier computing device in communication with the consumer computing device.

10. The system of splitting collaboration on event metrics for the supplier to respond to based on functional role as in claim 8, wherein the bid factors are presented to the suppliers as a RFx or a RFI.

11. The system of splitting collaboration on event metrics for the supplier to respond to based on functional role as in claim 8, wherein the sets of instructions when executed by the processor, further cause the processor to during analysis set up collaboration parameters within each of the plurality of review groups, and dates and times to have review complete for each user.

12. The system of splitting collaboration on event metrics for the supplier to respond to based on functional role as in claim 8, wherein each user is a collaborator and wherein each of the bid factors is restricted to collaborators not associated with the bid factor.

13. The system of splitting collaboration on event metrics for the supplier to respond to based on functional role as in claim 8, wherein the bid factors are questions presented to the suppliers.

14. The system of splitting collaboration on event metrics for the supplier to respond to based on functional role as in claim 8, wherein the sets of instructions when executed by the processor, further cause the processor to restrict view of bid factors based on the review group of the user.

15. A computer-readable medium having sets of instructions stored thereon which, when executed by a computer, cause the computer to:
establish a plurality of review groups, wherein each of the plurality of review groups includes at least one user;
associate bid factors to one or more of the plurality of review groups;
display each of the bid factors in accordance with the association of the bid factors with each of the plurality of review groups;
receive rankings for each of the bid factors from each of the plurality of review groups associated with the bid factors;
receive answers to each of the bid factors from at least one supplier;
rank each of the answers to the bid factors; and
correlate the rankings for each of the rankings of the bid factors and the rankings of the answers to generate a score for the at least one supplier.

16. The computer-readable medium as in claim 15, wherein the sets of instructions when further executed by the computer, cause the computer to:
receive additional bid factors; and
receive rankings for the additional bid factors.

17. The computer-readable medium as in claim 15, wherein the sets of instructions when further executed by the computer, cause the computer to rank each of the plurality of review groups, wherein the ranking of the review groups is factored in the generation of the score for the at least one supplier.

18. The computer-readable medium as in claim 15, wherein the sets of instructions when further executed by the computer, cause the computer to restrict view of bid factors based on the review group of the user.

19. The computer-readable medium as in claim 15, wherein more than one of the plurality of review groups are associated with at least one of the bid factors.

20. The computer-readable medium as in claim 15, wherein the plurality of review groups includes one or more of: a legal group, an IT group, or a functional group.
